(19) United States
(12) Patent Application Publication
(10) Pub. No.: US 2006/0123691 A1
(43) Pub. Date: Jun. 15, 2006

(54) Trotline drop hook organizers

(76) Inventor: Dan F. McBride III, Grand Cane, LA (US)

Correspondence Address: John M. Harrison, 2139 E. Bert Kouns, Shreveport, LA, 71105, US

(21) Appl. No.: 11/290,075

(22) Filed: Nov. 30, 2005

Related U.S. Application Data
(60) Provisional application No. 60/635,075, filed on Dec. 10, 2004.

(51) Int. Cl. A01K 97/00; E05C 19/12

(52) U.S. Cl. 43/57.3; 292/113

(57) ABSTRACT

Single and double keeper fishing trot line drop hook organizers are characterized in a first preferred embodiment by an elongated shaft having a hook keeper slidably mounted on or near the top end thereof under spring tension provided by a coiled spring also mounted on the shaft, beneath and contacting the hook keeper. A clip mount is slipped on the bottom end of the shaft and is spaced-apart from the hook keeper and includes multiple clip mount openings for receiving clips attached to one end of multiple drop hook lines, each having a hook attached to the opposite end. Each hook is designed to engage the rim of the hook keeper or embed in a resilient hook medium provided in the hook keeper when the clips are connected to the clip mount, responsive to tension applied to the respective drop hook lines by operation of the coiled spring. In another embodiment a pair of hook keepers are spring-loaded on the elongated shaft in tandem and a pair of corresponding clip mounts are provided on the opposite end of the shaft in spaced-apart relationship with respect to each other and the two hook keepers. Multiple drop hook lines are extended between the respective hook keepers and the corresponding clip mounts to maintain the drop lines in an organized and tensioned configuration.

### CROSS-REFERENCE TO RELATED APPLICATIONS

This application claims the benefit of and incorporates by reference prior filed copending U.S. Provisional Application Ser. No. 60/635,075, Filed Dec. 10, 2004.

### SUMMARY OF THE INVENTION

This invention relates to storage devices for organizing and storing drop hook lines for application to fishing trot lines and more particularly, to a single and double keeper trot line drop hook organizer for organizing multiple trot line drop hooks. In a preferred embodiment the single keeper drop line hook organizer is characterized by an elongated shaft fitted at or near the top end with a slidably-mounted, typically cylindrical hook keeper, which typically receives a quantity of hook medium such as an expanded foam or the like. The hook keeper is seated against a coiled spring fixed to the keeper shaft and engaging the bottom of the hook keeper. A retainer and pin combination is typically fixed to the shaft beneath the coiled spring to maintain the coiled spring in fixed position on the shaft, such that the hook keeper is seated on the top of the coiled spring and spring-loaded with respect to the shaft and the top spring retainer. A clip mount is similarly applied to the shaft in spaced-apart relationship with respect to the top hook keeper and includes multiple clip mount openings for removably receiving clips attached to one end of multiple drop hook lines. The opposite ends of the drop hook lines are each fitted with a hook designed to engage the hook keeper cup lip or rim or hook medium provided in the top hook keeper cup of the drop hook keeper, such that tension is applied to the drop hook lines by the spring located on the keeper shaft and engaging the bottom of the keeper cup element of the top hook keeper.

In another preferred embodiment of the invention a double keeper drop hook organizer is provided, wherein a pair of the hook keepers are slidably mounted on a common keeper shaft in a tandem arrangement and are each spring-loaded by coiled springs attached or fixed to the keeper shaft. A pair of corresponding clip mounts are spaced-apart on the keeper shaft with respect to each other and with respect to the hook keepers, respectively, and are fitted with multiple clip mount openings for receiving the clip ends of multiple drop hook lines. The opposite ends of the drop hook lines are each fitted with a hook which is inserted over the respective lip or rim of the keeper cups or in one of the two hook medium wafers or “donuts” provided in the respective keeper cups of the tandem-mounted hook keepers, such that tension is applied to the respective drop hook lines by operation of the coiled springs engaging the respective keeper cups.

In both of the embodiments described above, the hooks on each of the drop hook lines are quickly and easily removed from contact with the respective lip or rim or the hook medium wafers in the keeper cup or cups, by forcing the hook keeper or keepers downwardly on the keeper shaft against the tension in the coiled spring or springs, to create slack in the drop hook lines and then removing the respective hooks from the keeper cup(s) or the hook medium, as desired. Replacement of the drop hook lines is effected in reverse order.

### BRIEF DESCRIPTION OF THE DRAWINGS

The invention will be better understood by reference to the accompanying drawings, wherein:

FIG. 1 is a perspective view of a first single keeper drop hook organizer embodiment for organizing the drop hook lines of a trot line;

FIG. 2 is a front elevation of the single keeper drop hook organizer illustrated in FIG. 1;

FIG. 3 is an exploded view of the single keeper drop hook organizer illustrated in FIGS. 1 and 2;

FIG. 4 is a perspective view of a double keeper drop hook organizer embodiment, more particularly illustrating the maintaining of two sets of multiple drop hook lines in mounted and organized configuration thereon;

FIG. 5 is a perspective view of the double keeper drop hook organizer illustrated in FIG. 4, with a pair of drop hook lines detached from the double keeper drop hook organizer, more particularly illustrating a typical application of the double keeper drop hook organizer; and

FIG. 6 is an exploded view of the double keeper drop hook organizer illustrated in FIGS. 4 and 5 of the drawings.

### DESCRIPTION OF THE PREFERRED EMBODIMENTS

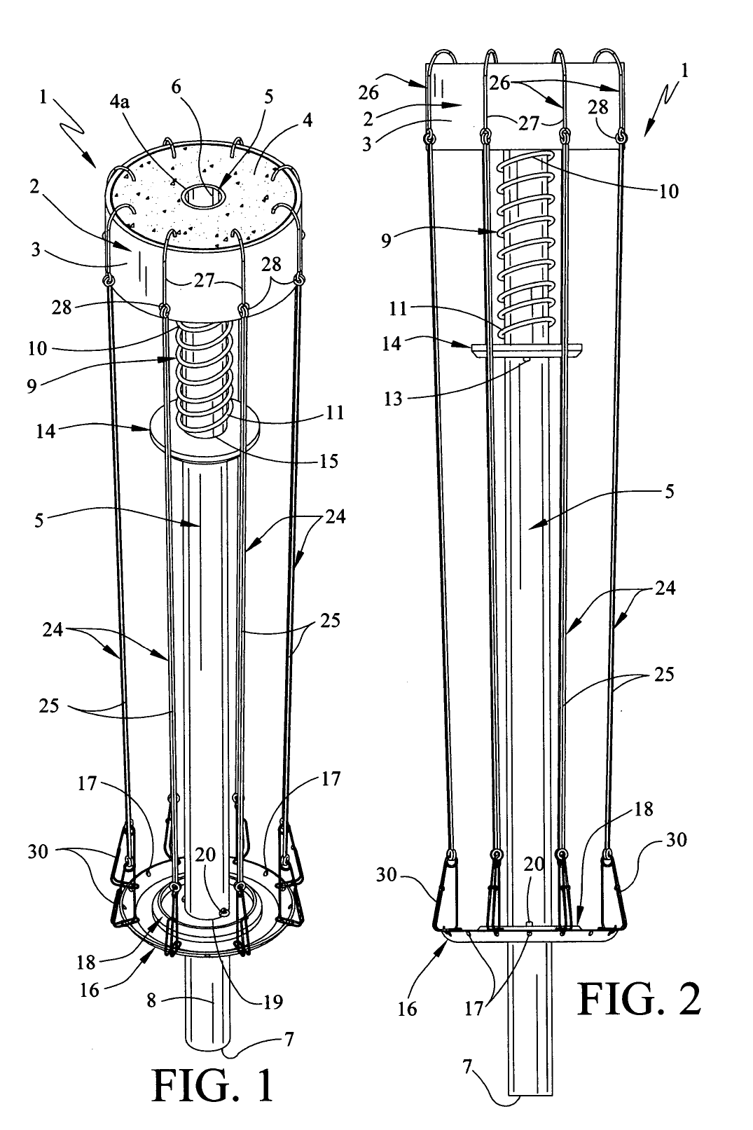

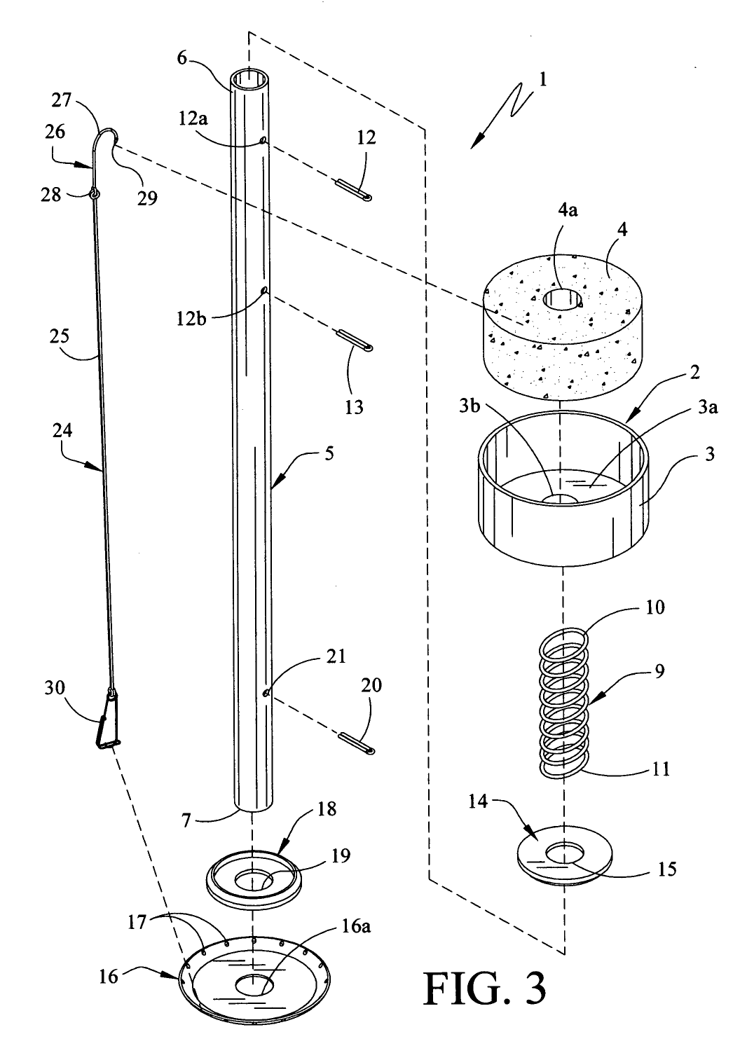

Referring initially to FIGS. 1-3 of the drawings in a first preferred embodiment of the invention, a single keeper drop hook organizer is generally illustrated by reference numeral 1 and is characterized by an elongated keeper shaft 5, receiving a typically cylindrically-shaped top hook keeper 2 which is slidably fitted to the top shaft end 6 of the keeper shaft 5. A top coiled spring 9 is also mounted on the keeper shaft 5 and the top spring end 10 of the top coiled spring 9 extends, along with the keeper shaft 5, through a bottom opening 3b in the cup bottom 3a of the keeper cup 3, as further illustrated in FIG. 3 of the drawings. A top spring mount pin 12, such as a cotter pin, is extended through a transversely-oriented top spring mount pin opening 12a located in the top shaft end 6 of the keeper shaft 5 and seats against the top spring end 10 of the top coiled spring 9 and the cup bottom 3a, as further illustrated in FIG. 3. Accordingly, the top spring mount pin 12 serves to prevent the keeper cup 3 of the top keeper 2 from moving upwardly away from the top coiled spring 9. A bottom spring mount pin 13 is extended through a similar transverse bottom spring mount pin opening 12b spaced-apart from the top spring mount pin opening 12a, for securing a top spring retainer 14 in place beneath the bottom spring end 11 of the top coiled spring 9 at a top spring retainer opening 15, as further illustrated in FIGS. 1-3 of the drawings. Accordingly, the top coiled spring 9 is inserted and mounted on that upper portion of the keeper shaft 5 which lies between the respective top spring mount pin 12 and bottom spring mount pin 13 to bias the keeper cup 3 of the top hook keeper 2 upwardly, as further illustrated in FIGS. 1 and 2 of the drawings. In a preferred embodiment a typically cylindrically-shaped wafer or “donut” of a suitable resilient hook medium 4 is inserted in the keeper cup 4, rests against the cup bottom 3a and the top spring mount pin 12 and includes a medium opening 4a, more particularly illustrated in FIG. 3, for registering with the bottom opening 3b in the cup bottom 3a and receiving the top shaft end 6 of the keeper shaft 5. The hook medium 4 may be characterized by an expanded foam material such as polyurethane or the like, of suitable density and resiliency, for the purpose of receiving the points 29 of various hooks 26, each having a shank 27 and an eye 28, on the drop hook lines 24, as hereinafter further described. Alternatively, the hook medium 4 may be omitted from the keeper cup 3 and the respective hooks 26 fitted over the lip or rim of the empty keeper cup 4, as hereinafter described.

Referring again to FIGS. 1-3 of the drawings a clip mount 16 is mounted in a slip-fit on the keeper shaft 5 at or near the opposite or bottom shaft end 7 and the keeper shaft 5 may be extended below the clip mount 16 to define a shaft handle 8, as desired. Multiple clip mount openings 17 are provided in the periphery of the typically round clip mount 16 and a shaft opening 16a is provided in the middle of the clip mount 16 for accommodating the keeper shaft 5. A clip mount retainer 18 is typically also fitted to the bottom shaft end 7 of the keeper shaft 5, above the clip mount 16 at the clip mount retainer opening 19. The clip mount retainer 18 is maintained in place on the keeper shaft 5 in fixed relationship with respect to the clip mount 16 and the keeper shaft 5, by means of a clip mount pin 20, which extends through a corresponding transversely-oriented clip mount pin opening 21, located in the keeper shaft 5 above the bottom shaft end 7, as illustrated. Accordingly, the clip mount 16 is maintained in place on the keeper shaft 5 against the clip mount retainer 18, by the tension in the respective drop hook lines 24.

As further illustrated in FIGS. 1-3 of the drawings the multiple drop hook lines 24 are each characterized by a flexible line 25 of selected material, size and strength, having one end secured to an eye 28 at one end of the shank 27 of a hook 26 having a point 29 at the curved opposite end, and the opposite end of the flexible lines 25 each attached to a corresponding clip 30. Each of the clips 30 is extended through a corresponding clip mount opening 17 provided in the clip mount 16 and is removably secured thereon in conventional fashion. Each of the hooks 26 attached to the opposite ends of the respective flexible lines 25 of the drop hook lines 24 is extended to the top of the top hook keeper 2 and the point 29 is either embedded in the hook medium 4 located in the top hook keeper 2 as further illustrated in FIGS. 1 and 2 of the drawings, or positioned over the top edge or lip of the keeper cup 3, if no hook medium 4 is used. This arrangement maintains tension in the flexible lines 25 by virtue of the tension in the top coiled spring 9, which tension is exerted against the cup bottom 3a of the keeper cup 3, since the top hook keeper 2 is slidably mounted on the keeper shaft 5. Accordingly, release of the respective drop hook lines 24 from the hook medium 4 or the lip of the keeper cup 3 and the top hook keeper 2 is effected by applying hand or finger pressure downwardly against the keeper cup 3 to slidably displace the top hook keeper 2 on the top shaft end 6 of the keeper shaft 5, create slack in the flexible lines 25 of each of the drop hook lines 24 and enable quick and easy removal of the respective hooks 26 from the hook medium 4 or the lip or rim of the keeper cup 3. Each clip 30 is then removed from a corresponding clip mount opening 17 in the clip mount 16 to free the respective drop hook lines 24 from the single keeper drop hook organizer 1. Replacement of the respective drop hook lines 24 on the top hook keeper 2 is effected in like reverse manner and release of hand or finger pressure from the top hook keeper 2 re-establishes tension in the flexible lines 25 of the respective drop hook lines 24.

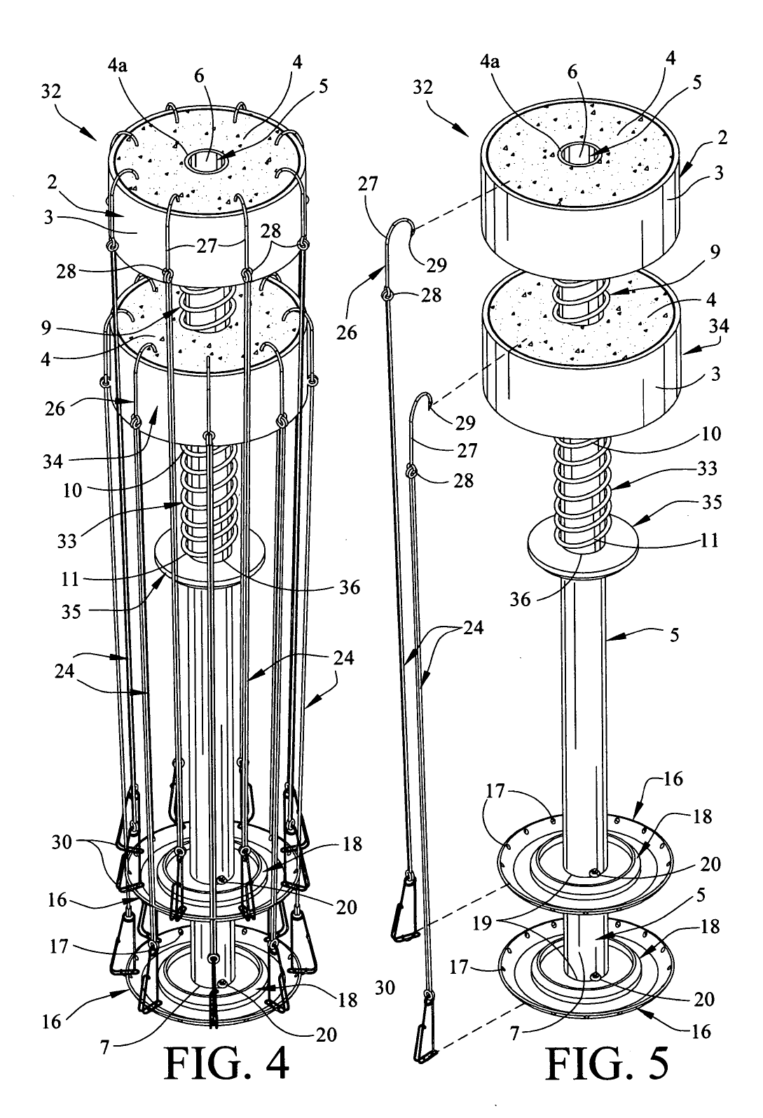

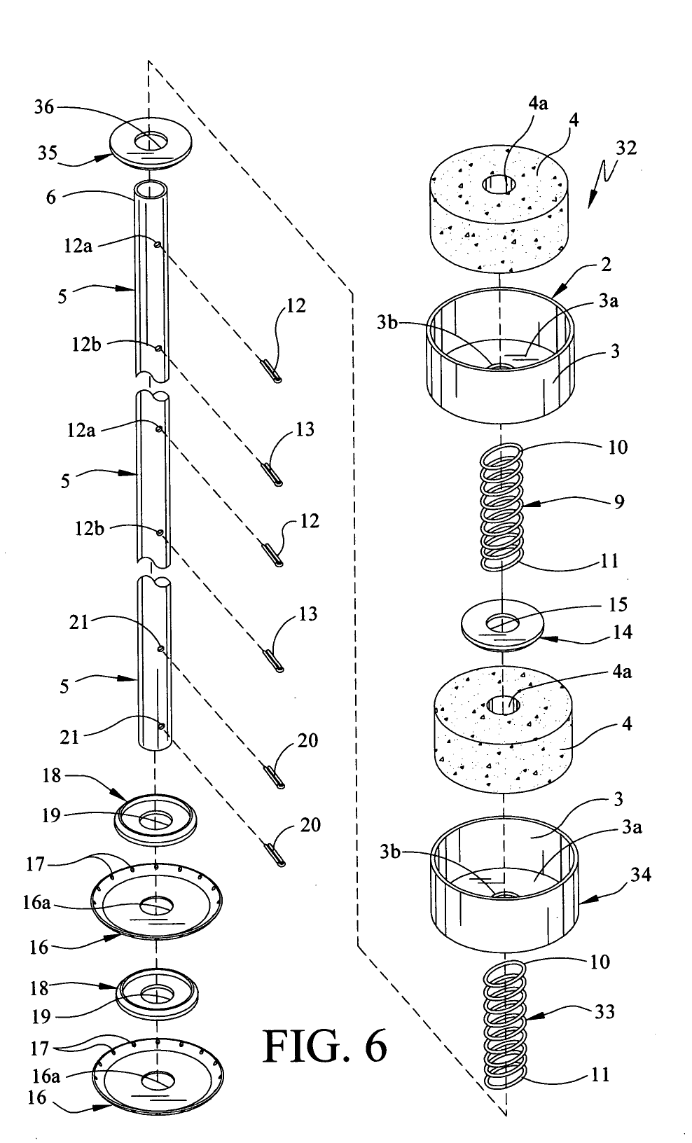

Referring now to FIGS. 4-6 of the drawings in another preferred embodiment of the invention, a double keeper drop hook organizer 32 is illustrated and also includes an elongated keeper shaft 5 having a top shaft end 6 and a bottom shaft end 7. A top hook keeper 2 is slidably mounted on or near the top shaft end 6 of the keeper shaft 5 in the same manner as illustrated in FIGS. 1-3 of the drawings. As described above, the top coiled spring 9, fixed to the keeper shaft 5 beneath the keeper cup 3 of the top hook keeper 2, serves to maintain pressure on the top hook keeper 2 and tension in each of the drop hook lines 24, since the opposite ends of the drop hook lines 24 are attached by means of corresponding clips 30 to a clip mount 16, as further above described with respect to the embodiment illustrated in FIGS. 1-3 of the drawings. A bottom hook keeper 34 is also slidably disposed on the keeper shaft 5, beneath and in tandem orientation with the top hook keeper 2 and is fitted with a bottom coiled spring 33, typically mounted on the keeper shaft 5 by means of a bottom spring retainer 35, having a bottom spring retainer opening 36 that fits on the keeper shaft 5 beneath the bottom spring end 11 of the bottom coiled spring 33. The keeper shaft 5 projects through the bottom opening 3b in the cup bottom 3a of the keeper cup 3 element of the bottom hook keeper 34. A top spring mount pin 12 and bottom spring mount pin 13 are extended through corresponding transversely-oriented top spring mount pin openings 12a (located above the bottom opening 3b) and bottom spring mount pin openings 12b, respectively, as further illustrated in FIG. 6 of the drawings. Accordingly, the top hook keeper 2 and the bottom hook keeper 34 are similarly mounted in sliding relationship on the keeper shaft 5 in tandem orientation with respect to each other, against the bias of the respective fixed top coiled spring 9 and bottom coiled spring 33. A second clip mount 16 is also fitted on the keeper shaft 5 at or near the bottom shaft end 7, typically by means of a clip mount retainer 18, having a clip mount retainer opening 19 for accommodating the keeper shaft 5. A second clip mount pin 20 extends through a corresponding clip mount pin opening 21 transversely located in the bottom shaft end 7 of the keeper shaft 5 in spaced-apart relationship with respect to the first clip mount pin opening 21, to secure both the clip mount retainer 18 and the clip mount 16 in position, spaced-apart from each other on the keeper shaft 5, as illustrated in FIGS. 4-6 of the drawings.

It will be appreciated from a consideration of FIGS. 4 and 5 of the drawings that the double keeper drop hook organizer 32 is capable of receiving, organizing and storing more drop hook lines 24 than is possible using the single keeper drop hook organizer 1 embodiment illustrated in FIGS. 1-3. This facility is realized because of the doubling effect of using a top hook keeper 2 and a bottom hook keeper 34, as well as a corresponding pair of spaced-apart clip mounts 16. Accordingly, multiple drop hook lines 24 can be tensioned in place between the corresponding top hook keeper 2 and one of the clip mounts 16 and the bottom hook keeper 34 and the other of the clip mounts 16, as further illustrated in FIG. 4 of the drawings. As in the case of the single keeper drop hook organizer 1 illustrated in FIGS. 1-3 of the drawings, the respective hooks 26 attached to one end of each of the corresponding flexible lines 25 in each of the drop hook lines 24 can be embedded in the donut or wafer-shaped hook medium 4, placed in the keeper cups 3 of the top hook keeper 2 and the bottom hook keeper 34, respectively. Alternatively, as described above, the hooks 26 can be positioned over the respective lips or rims of the keeper cups 3 for the same purpose. Furthermore, the clips 30 attached to the opposite ends of the flexible lines 25 are quickly and easily removably secured to corresponding ones of the clip mount openings 17 in the two clip mounts 16, respectively.

Referring again to FIGS. 4 and 5 of the drawings, access of the respective drop hook lines 24 and removal of the corresponding hooks 26 from the respective hook medium 4 or the rim or lip of the keeper cup or cups 3 in the top hook keeper 2 and the bottom hook keeper 34, is effected by applying downward pressure to either the top hook keeper 2 or the bottom hook keeper 34, against the respective tension in the top coiled spring 9 and the bottom coiled spring 33 and creating corresponding slack in the drop hook lines 24, for removal of the respective hooks 26 and clips 30, as described heretofore with respect to the embodiment illustrated in FIGS. 1-3.

It will be appreciated by those skilled in the art that the single keeper drop hook organizer 1 and the double keeper drop hook organizer 32 of this invention can be designed in several different ways, including the provision of a top hook keeper 2 and a bottom hook keeper 34 of various size and shape, for example, in polygon configurations rather than as a cylinder, according to the desires of those skilled in the art. Furthermore, the nature, consistency and density of the optional hook medium 4 provided in the keeper cup 3 of both the top hook keeper 2 and the bottom hook keeper 34 can be chosen further according to the knowledge of those skilled in the art. Additionally, it will be appreciated that the shape of the clip mounts 16 and the number of clip mount openings 17 provided in the clip mounts 16 can be selected such that a selected number of drop hook lines 24 are organized on both the single keeper drop hook organizer 1 and the double keeper drop hook organizer 32, further according to the desires of the user. The length of the keeper shaft 5 and the spacing between the respective keeper cup or cups 3 and the corresponding clip mount or mounts 16 can also be selected according to the desired length of the drop hook lines 24.

It will be understood from a consideration of the above that the single keeper drop hook organizer 1 and the double keeper drop hook organizer 32 are characterized by convenience, portability, safety and flexibility, in that multiple drop hook lines 24 of desired length and size of the hooks 26 can be safely stored without entanglement until it is desired to remove the drop hook lines 24 and attach them to a primary trot line support cord or line by means of the respective clips 30. For example, a trot line support cord (not illustrated) of selected length having loops or clips provided at selected intervals along the cord length can be supplied with the drop hook lines 24 as the clips 30 are attached to the loops or clips in the trot line cord. The drop hook lines 24 can therefore be quickly and easily installed and disassembled from the loops or clips provided on the trot line cord and then placed in the single keeper drop hook organizer 1 or the double keeper hook organizer 32, as heretofore described.

While the preferred embodiments have been described above, it will be recognized and understood that various modifications may be made in the invention and the appended claims are intended to cover all such modifications which may fall within the spirit and scope of the invention.

Having described my invention with the particularity set forth above, what is claimed is:

1. A trot line drop hook organizer for organizing drop hook lines having a hook on one end and a clip on the opposite end, comprising a shaft; at least one hook keeper slidably disposed on said shaft for receiving the hook; at least one spring provided on said shaft, said spring engaging said hook keeper, wherein said spring is tensioned and said hook keeper is displaced on said shaft responsive to pressure applied to said hook keeper; and at least one clip mount provided on said shaft in spaced-apart relationship with respect to said hook keeper for receiving the clip, wherein the hook is caused to selectively engage and disengage said hook keeper when the clip is secured to said clip mount and said pressure is applied to said hook keeper.

2. The trot line drop hook organizer of claim 1 comprising a hook medium provided in said hook keeper for receiving the point of the hook when the drop hook lines are mounted on said trot line drop hook organizer.

3. The trot line drop hook organizer of claim 1 comprising a plurality of clip mount holes provided in said clip mount for selectively receiving the clip and removably securing the clip to said clip mount.

4. The trot line drop hook organizer of claim 1 comprising:
(a) a hook medium provided in said hook keeper for receiving the point of the hook when the drop hook lines are mounted on said trot line drop hook organizer; and
(b) a plurality of clip mount holes provided in said clip mount for selectively receiving the clip and removably securing the clip to said clip mount.

5. The trot line drop hook organizer of claim 1 wherein said at least one hook keeper comprises a single hook keeper slidably disposed on said shaft and said at least one clip mount comprises a single clip mount seated on said shaft and spaced-apart from said hook keeper.

6. The trot line drop hook organizer of claim 5 comprising a hook medium provided in said hook keeper for receiving the point of the hook when the drop hook lines are mounted on said trot line drop hook organizer.

7. The trot line drop hook organizer of claim 5 comprising a plurality of clip mount holes provided in said clip mount for selectively receiving the clip and removably securing the clip to said clip mount.

8. The trot line drop hook organizer of claim 5 comprising:
(a) a hook medium provided in said hook keeper for receiving the point of the hook when the drop hook lines are mounted on said trot line drop hook organizer; and
(b) a plurality of clip mount holes provided in said clip mount for selectively receiving the clip and removably securing the clip to said clip mount.

9. The trot line drop hook organizer of claim 1 wherein said at least one hook keeper comprises a pair of hook keepers slidably disposed on said shaft in a spaced-apart, tandem disposition with respect to each other; said at least one spring comprises a first spring mounted on said shaft and engaging a first one of said pair of hook keepers and a second spring mounted on said shaft and engaging the second one of said pair of hook keepers; and said at least one clip mount comprises a pair of clip mounts provided on said shaft in spaced-apart relationship with respect to each other and with respect to said hook keepers, wherein first selected ones of the drop hook lines are removably mounted on said first one of said pair of hook keepers and a first one of said pair of clip mounts and second selected ones of the drop hook lines are removably mounted on said second one of said pair of hook keepers and the second one of said pair of clip mounts.

10. The trot line drop hook organizer of claim 9 comprising a hook medium provided in at least one of said pair of hook keepers for receiving the point of a hook when the drop hook lines are mounted on said trot line drop hook organizer.

11. The trot line drop hook organizer of claim 9 comprising a plurality of clip mount holes provided in said pair of clip mounts, respectively, for selectively receiving the clip and removably securing the clip to said clip mounts, respectively.

12. The trot line drop hook organizer of claim 9 comprising:
(a) a hook medium provided in said pair of hook keepers for receiving the point of a hook when the drop hook lines are mounted on said trot line drop hook organizer; and
(b) a plurality of clip mount holes provided in said pair of clip mounts, respectively, for selectively receiving the clip and removably securing the clip to said clip mounts, respectively.

13. A trot line drop hook organizer for organizing drop hook lines having hooks and clips connected by a line, comprising a shaft; a hook keeper slidably disposed on said shaft for removably accessing the hooks; a coiled spring provided on said shaft for engaging said hook keeper; and a clip mount carried by said shaft in spaced-apart relationship with respect to said hook keeper for removably receiving the clips, wherein said hook keeper is slidably displaced on said shaft for selectively engaging and disengaging the hooks with and from said hook keeper, respectively.

14. The trot line drop hook organizer of claim 13 comprising a hook medium provided in said hook keeper for receiving the point of the hooks when the drop hook lines are mounted on said trot line drop hook organizer.

15. The trot line drop hook organizer of claim 13 comprising a plurality of clip mount holes provided in said clip mount for receiving the clips and removably securing the clips to said clip mount.

16. The trot line drop hook organizer of claim 13 comprising:
(a) a hook medium provided in said hook keeper for receiving the point of the hooks when the drop hook lines are mounted on said trot line drop hook organizer; and
(b) a plurality of clip mount holes provided in said clip mount for receiving the clips and removably securing the clips to said clip mount.

17. A hook and line organizer for organizing drop hook lines having hooks and clips connected by lines, comprising a shaft; a first hook keeper slidably disposed on said shaft and a first coiled spring secured to said shaft and engaging said first hook keeper; a second hook keeper slidably disposed on said shaft in spaced-apart relationship with respect to said first hook keeper and a second coiled spring secured to said shaft and engaging said second hook keeper; a first clip mount disposed on said shaft in spaced-apart relationship with respect to said first hook keeper and said second hook keeper; and a second clip mount disposed on said shaft in spaced-apart relationship with respect to said first hook keeper, said second hook keeper and said first clip mount, wherein said first hook keeper is slidably displaced on said shaft against the tension in said first coiled spring and said second hook keeper is slidably displaced on said shaft against the tension in said second coiled spring responsive to pressure applied to said first hook keeper and said second hook keeper, for selectively engaging and disengaging the hooks and said first hook keeper and said second hook keeper, respectively.

18. The hook and line organizer of claim 17 comprising a hook medium provided in said first hook keeper and said second hook keeper, respectively, for receiving the point of the hooks when the drop hook lines are mounted on said hook and line organizer.

19. The hook and line organizer of claim 17 comprising a plurality of clip mount holes provided in said first clip mount and said second clip mount, respectively, for receiving the clips and removably securing the clips to said first clip mount and said second clip mount, respectively.

20. The hook and line organizer of claim 17 comprising:
(a) a hook medium provided in said first hook keeper and said second hook keeper, respectively, for receiving the point of the hooks when the drop hook lines are mounted on said hook and line organizer; and
(b) a plurality of clip mount holes provided in said first clip mount and said second clip mount, respectively, for receiving the clips and removably securing the clips to said first clip mount and said second clip mount, respectively.
